(19) United States
(12) Patent Application Publication
(10) Pub. No.: US 2005/0212794 A1
(43) Pub. Date: Sep. 29, 2005

(54) Method and apparatus for removing of shadows and shadings from texture images

(75) Inventors: Ryo Furukawa, Tokyo (JP); Rieko Kadobayashi, Tokyo (JP)

Correspondence Address: STAAS & HALSEY LLP, SUITE 700, 1201 NEW YORK AVENUE, N.W., WASHINGTON, DC, 20005, US

(73) Assignee: Communications Research Laboratory, Independent Administrative Institution, Tokyo (JP)

(21) Appl. No.: 10/810,641

(22) Filed: Mar. 29, 2004

(51) Int. Cl. G06T 15/00; G09G 5/00; G06T 17/00

(52) U.S. Cl. 345/419; 345/582

(57) ABSTRACT

This apparatus calculates a direction of a light source (the sun) in a coordinate system having a 3D geometrical model of an object placed therein from geographic information on an object and a shooting time of image data, and detects a shadow region cast on the 3D geometrical model by a beam from a light source direction so as to identify the shadow region in the image data based on correspondence information. It uses a predetermined reflection model to estimate effects of shadings caused to the 3D geometrical model and determines a parameter of a reflection model suited to estimated shadings. And it performs calculation for removing the effects of the shadows and shadings by using the determined parameter from pixel values sampled from the image data so as to fit the calculated pixel values in the 3D geometrical model and generate a texture model.

### BACKGROUND OF THE INVENTION

1. Field of the Invention

This invention relates to a method and an apparatus for generating a 3D texture model by using a computer. To be more specific, the present invention relates to a processing method wherein the 3D texture model is generated by removing effects of shadows and shadings cast during shooting from image data shot outdoors and performing texture mapping for the sake of generating the 3D texture model of a structure having a surface appearing a rough material such as a stone architecture of ruins.

2. Description of the Related Art

A 3D texture model of a structure is generated as follows. First, an object is measured with a 3D laser range scanner. To obtain an actual texture of the object, high-resolution image data is shot with a digital camera. Thereafter, geometrical information is obtained from measurement data of the scanner, and a 3D geometrical model is generated. Furthermore, a correspondence between a 3D geometrical model and image data as to their positions and points on the surface is used to map the 3D geometrical model with data sampled from the image data so as to generate the 3D texture model.

It is helpful to archive the structures such as ruins and historical buildings as the 3D texture models. If the 3D texture models are archived without being subject to a specific lighting condition, free use of the models can be expected and a significant contribution can be made to studies in various fields.

Many of the structures as the objects of archiving have a surface appearing like a rough material. And the structures are generally located outdoors. For that reason, the image data used for texture mapping is usually shot outdoors in the daytime, and is apt to be affected by sunlight. To be more specific, shadows and shadings generated by the sunlight are reflected in a scene of the image data of the object. Therefore, it is necessary to remove effects of the shadows and shadings from the image data in order to generate the 3D texture model of which lighting condition is not identified. To be more specific, it is necessary to separate the effects of the shadows and shadings from material colors (i.e. reflectance information) of the object of the image data.

There are some known techniques of removing the effects of the shadows and shadings from the image data. The technique in the past required in each scene a plurality of pieces of image data shot from the same camera position under different lighting conditions. It is difficult in many cases, however, to prepare a plurality of pieces of image data in each scene. In particular, the lighting conditions cannot be freely controlled in the case of outdoor shooting. If a light source is the sun, it takes a very long time to take some shots under the different lighting conditions.

There is the technique of Tappen et al. as one of the techniques in the past. This technique classifies edges in the image data into those generated by a change in reflection of the material and those generated by the shadings. This classification is based on clues to color changes and a machine learning method. However, this technique depends on the color in each region being uniform, and so it is not suited to the objects having a surface rich in texture such as a stone architecture. [Tappen, M. F., Freeman, W. T. and Adelson, E. H., “Recovering intrinsic images from a single image, in Advances in Neural Information Processing Systems 15 (NIPS), 2003]

The technique of Finlayson et al. is the one in which the light source described by a “black box model” reportedly suited to outdoor scenes widely is assumed, and the edges generated by cast shadows are extracted by using constraints in a spectral region. As for this technique, however, how to handle the influence of the shadings is not clarified. [Finlayson, G. D., Hordley, S. D. and Drew, M. S., “Removing shadows from images” in Computer Vision-ECCV2002, p.p. 823-836]

### SUMMARY OF THE INVENTION

An object of the present invention is to provide a processing method and a processing apparatus for performing a process of removing influence of shadows and shadings from image data by using only one piece of the image data in a process of performing texture mapping by using the image data shot outdoors for the sake of generating a 3D texture model of a structure having a rough surface such as a building of ruins.

The present invention obtains a 3D geometrical model for expressing a 3D form of an object in a polyhedron based on geometrical information, and also obtains geographic information including latitude and longitude indicating a position of the object and orientation of the object. It also obtains the image data of the object shot with the sun as a light source and correspondence information indicating correspondence between a scene expressed by the image data and the 3D geometrical model as to their positions and forms, and further obtains shooting information including information on a shooting time and shooting situation of the image data.

And it places the 3D geometrical model of the object in a predetermined local coordinate system based on the geographic information and geometrical information, and calculates a light source direction, that is, the direction of the sun in the local coordinate system by using the geographic information and the shooting time. It detects a shadow region cast on the surface of the 3D geometrical model by a beam from the light source by using the calculated light source direction so as to identify the shadow region on the image data based on the correspondence information. It uses a predetermined reflection model to estimate effects of the shadings caused to the 3D geometrical model by the beam from the light source, and determines a parameter of the reflection model for expressing estimated shadings. And it performs calculation for removing the effects of the shadows and shadings by using the determined parameter from pixel values sampled from the image data based on the correspondence information so as to fit the calculated pixel values in the 3D geometrical model and generate the 3D texture model.

According to the present invention, it is not necessary to prepare a plurality of pieces of image data shot from the same shooting position under different lighting conditions. For this reason, it is possible to alleviate temporal and resource-related costs for obtaining the image data.

According to the present invention, it is possible to estimate the effects of the shadings as to the entire 3D geometrical model of the object even in the case of the object of which brightness successively changes in the scene of the image data. According to the present invention, it is possible to implement the texture mapping having appropriately removed the gradual effects of the shadings of the image data.

It is also possible, according to the present invention, to generate the 3D texture model not dependent on a specific lighting condition by using one piece of image data shot outdoors. According to the present invention, it is possible to provide the 3D texture model capable of expression corresponding to an arbitrary lighting condition.

### BRIEF DESCRIPTION OF THE DRAWINGS

FIG. 1 is a diagram showing a configuration example of a 3D texture model generation apparatus for implementing the present invention;

FIG. 2 is a diagram for explaining a processing flow of the present invention;

FIG. 3 is a diagram showing a formula (1) for calculating a light source direction;

FIG. 4 is a diagram showing a formula (2) as an example of expression of an Oren-Nayar model;

FIG. 5 is a diagram showing a formula (4) and a formula (5) as examples of expression of the Oren-Nayar model;

FIG. 6 is a diagram showing an example of image data of a first sample;

FIG. 7 is a diagram showing an example of a detected shadow region;

FIG. 8 is a diagram showing an example of effects of the shadings estimated by an optimized parameter;

FIG. 9 is a diagram showing an example of results of removing the effects of the shadows and shadings from the image data;

FIG. 10 is a diagram showing an example of the image data of a second sample;

FIG. 11 is a diagram showing an example of effects of the shadings estimated with an optimized parameter;

FIG. 12 is a diagram showing an example of the results of removing the shadows and shadings from the image data; and

FIGS. 13 are diagrams showing an enlarged portion of the results shown in FIG. 12.

### DETAILED DESCRIPTION OF THE PREFERRED EMBODIMENTS

Hereafter, preferred embodiments of the present invention will be described.

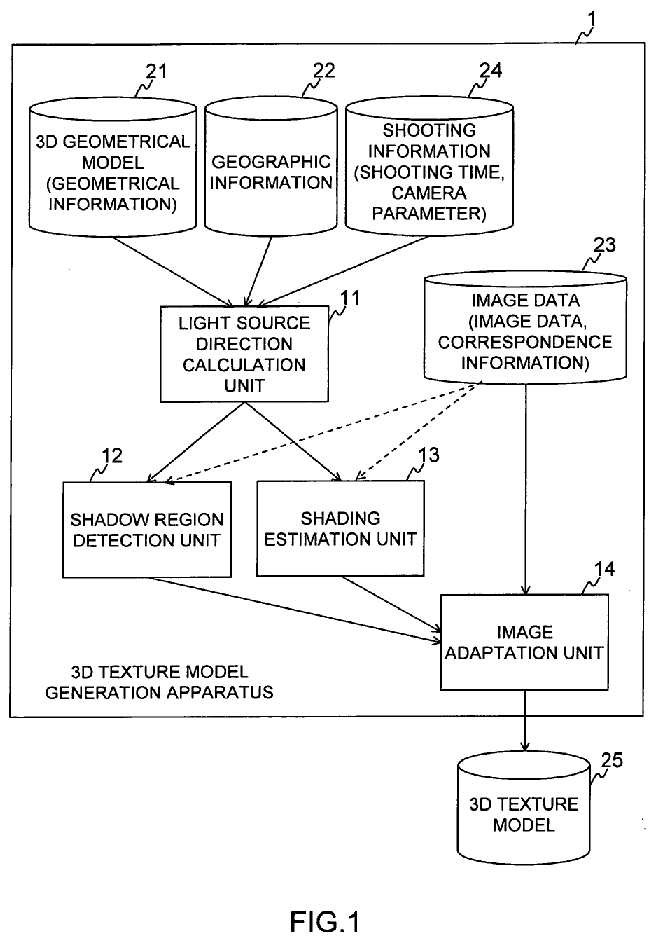

FIG. 1 is a diagram showing a configuration example of a 3D texture model generation apparatus for implementing the present invention. A 3D texture model generation apparatus 1 is an apparatus for mapping a 3D geometrical model 21 with image data 23 shot outdoors to generate a 3D texture model 25. The 3D texture model generation apparatus 1 comprises a light source direction calculation unit 11, a shadow region detection unit 12, a shading estimation unit 13 and an image adaptation unit 14.

The 3D geometrical model 21 is a data model for expressing a 3D form of an object in a polyhedron based on geometrical information generated from measurement data of the object measured with a device for measuring the forms such as a 3D laser range scanner. Geographic information 22 is data on latitude, longitude, altitude and direction as to a position of the object. The geographic information 22 can be obtained by a GPS (Global Positioning System).

The image data 23 is high-resolution image data of the object shot for texture mapping with a digital camera. The image data 23 is shot outdoors, that is, with the sun as a light source. The image data 23 is given correspondence information for defining correspondence between each scene thereof and the 3D geometrical model 21 as to their positions and points on the surface. The correspondence information is obtained by estimating a projection matrix of the 3D geometrical model 21 and using camera calibration used as a technique of the non-linear optimization.

The shooting information 24 is the data including time data on a shooting time (hour, minute and second) recorded by a camera when shooting the image data 23 and camera parameters relating to the shooting with the camera. The term “camera” is used herein in a comprehensive sense, i.e., to broadly refer to device which can obtain image data of object.

In this example, it is assumed that there may be a texture on a surface of the object and distributions of the reflectance are not dependent on the positions on the surface. This hypothesis is a consequence of a fact that walls of the object are made of stone having a similar looking as a material. To be more specific, a certain texture has a similar appearance on the entire surface even if there are clear edges on the image data 23.

The light source direction calculation unit 11 is a processing portion for calculating the direction of the light source (the sun) in a certain local coordinate system in which the 3D geometrical model 21 of the object is placed based on the geographic information 22 and shooting information 24 on the object.

The shadow region detection unit 12 uses the light source direction calculated by the light source direction calculation unit 11 to detect the shadow region cast on the surface of the 3D geometrical model 21 by the beam from the light source so as to identify the shadow region of the image data 23 based on the correspondence information.

The shading estimation unit 13 estimates the effects of the shadings generated in the 3D geometrical model 21 by the beam from the light source by using a predetermined reflection model so as to determine the parameter of the reflection model expressing the estimated shadings. The shading estimation unit 13 uses as the reflection model a known Oren-Nayar model as one of BRDFs (bidirectional reflectance distribution functions). The Oren-Nayar model is suited to the reflection model of the object having the surface appearing a rough material.

The image adaptation unit 14 is a processing portion for performing calculation for removing the effects of the shadows and shadings by using the parameter determined by the shading estimation unit 13 from pixel values sampled from the image data 23 based on the correspondence information.

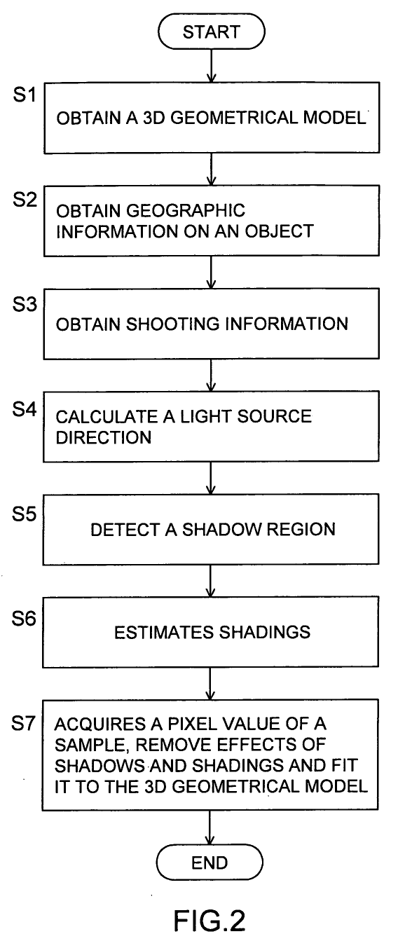

FIG. 2 is a diagram for explaining a processing flow of the present invention.

First, the light source direction calculation unit 11 of the 3D texture model generation apparatus 1 obtains the 3D geometrical model 21 (step S1). Furthermore, the light source direction calculation unit 11 obtains the geographic information 22 of the object (step S2) and obtains the shooting information 24 (step S3).

The light source direction calculation unit 11 calculates the light source direction based on the 3D geometrical model 21, geographic information 22 and shooting information 24 (step S4).

The light source direction calculation unit 11 grasps a relationship between the 3D geometrical model 21 and the earth by using the geographic information 22, and places the 3D geometrical model 21 in a local coordinate system 0₁. An x-axis of the position coordinate system 0₁ indicates an east direction, a y-axis indicates a north direction and a z-axis indicates a vertical direction. An xy-surface is horizontal. And the direction of the sun expressed by the coordinate system 0₁ is a vector (sₓ, s_{y}, s_{z}).

The light source direction calculation unit 11 calculates the direction of the sun in the coordinate system 0₁ from the geographic information 22 and the shooting time of shooting information 24 on the 3D geometrical model 21.

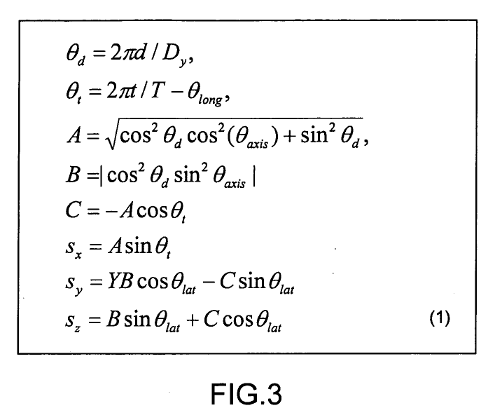

FIG. 3 shows a formula (1) for calculating the vector (sₓ, s_{y}, s_{z}) in the light source direction. In the formula (1), θ_{long} indicates longitude of a place at which the object (3D geometrical model 21) is located. A longitude value is a signed angle measured westward from the Greenwich meridian. θₗₐₜ indicates latitude of a place at which the object is located. A latitude value is an actual measurement value measured northward from the equator as 0 degree. Reference character d denotes the number of elapsed days from summer solstice. Reference character D denotes the number of days of a year. Reference character t denotes the value wherein the shooting time of the image data 23 of the object expressed as Greenwich time is converted to the number of elapsed seconds from 0 a.m. Reference character T denotes the value expressing length of one day as the number of seconds. θₐₓᵢₛ indicates an angle between the axis of the earth and a normal direction of the ecliptic plane.

Next, the shadow region detection unit 12 detects the shadow region cast on the 3D geometrical model 21 as follows (step S5).

The shadow region detection unit 12 uses the coordinate system 0₁ in which the 3D geometrical model 21 and the direction of the sun (sₓ, s_{y}, s_{z}) are identified, and detects the shadow region cast on the surface of the 3D geometrical model 21 by a known shadow region calculation method. Furthermore, it maps the surface of a detected shadow portion on the image data 23 based on the correspondence information on the 3D geometrical model 21 and the image data 23 so as to determine a shadow pixel set Rₛ. The shadow pixel set Rₛ is a set of pixels of one shadow region or a plurality of shadow regions cast in the scene of the image data 23. The shadows generated by a body nonexistent in the 3D geometrical model 21 are not detected.

Next, the shading estimation unit 13 estimates the effects of the shadings as follows (step S6).

Next, the shading estimation unit 13 estimates the effects of the shadings generated to the 3D geometrical model 21 by the calculated direction of the light source by using the Oren-Nayar model which is one of the reflection models described in BRDF.

A BRDF formula takes the direction of incident ray (wᵢ) and the direction of reflected ray (wᵣ) as arguments. This formula maps the arguments to a rate between the radiance and the irradiance. The radiance is the radiant flux normalized by a solid angle and orthogonal area. The irradiance is energy of incident light from the direction wᵢ.

In the Oren-Nayar model, roughness of the surface is modeled with innumerable V-grooves on the surface. The quantity of roughness is expressed as a parameter of distribution of angles of gradient of the V-grooves. Here, the model expresses influence of mutual reflection caused by the beam reflected up to twice.

The Oren-Nayar model is adopted for the following reasons. Firstly, the surface of the wall of the object is often made of rough stone, in that case the material itself is suited to modeling with the Oren-Nayar model which is fit for the object having the surface reflecting diffusely. Secondly, a resolution of the 3D geometrical model 21 obtained by the 3D laser range scanner is rougher than sizes of bumps on the surface of the image data 23. As the BRDF formula requires a shape parameter (normal vector), light intensities of the surface must be sampled at the same resolution as that of the 3D geometrical model 21 in order to adapt intensities of the surface to the BRDF formula. The bumps on the surface of the size smaller than a geometric resolution can be considered as the roughness of the surface.

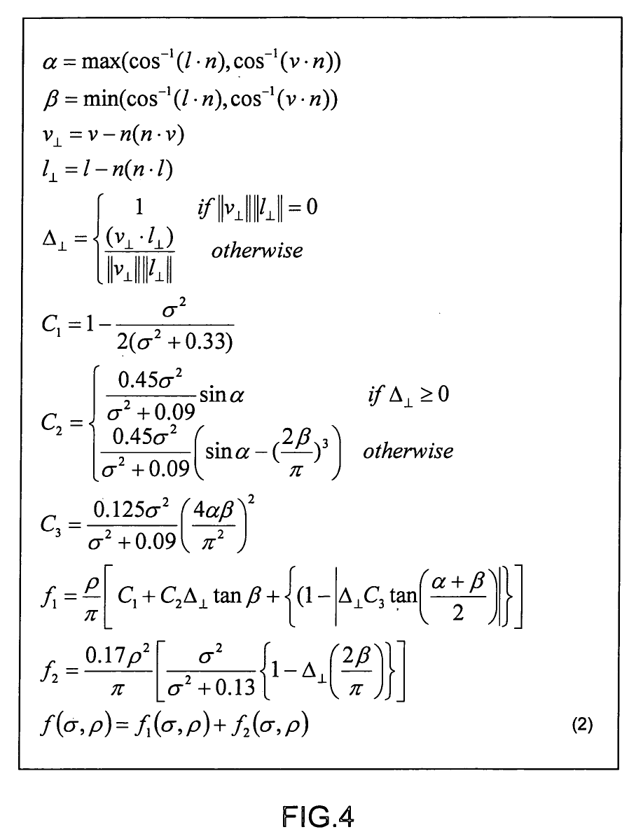

FIG. 4 shows a formula (2) which is an example of expression of the value f of the BRDF formula at a surface position (point) in the Oren-Nayar model. In the formula (2), l denotes the direction of the incident light expressed as a direction vector from a surface point to the light source. v denotes the direction of a line of sight expressed as the direction vector from the surface point to the camera. n denotes a normal vector of the geometrical model at the surface point. σ denotes a standard deviation of the distribution of angles of gradient of the V-grooves indicating the roughness of the surface (assumed to have normal distribution). ρ denotes a reflection rate of the surface of the V-grooves. f₁ represents the effects of direct reflection from the surface of the V-grooves. f₂ represents the effects of interreflection.

If (M^{r}, M^{g}, M^{b}) is material colors, (L^{r}_{d}, L^{g}_{d}, L^{b}_{d}) denotes the intensity of a direct light source (the sun). These elements indicate wavelengths of RGB respectively. (L^{r}ₑ, L^{g}ₑ, L^{b}ₑ) denotes brightness of environment light (light from the sky, indirect light from each direction, etc.). (I^{r}, I^{g}, I^{b}) denotes an apparent intensity (pixel value for instance) of the scene detected by the camera. If it is assumed that the reflection of the environment light is in proportion to the material color having a ratio of Cₑ, the pixel value I^{c} (c∈{r, g, b}) can be expressed as in the following formula (3).
I^{c}=M^{c}L_{d}^{c}R(l,v,n,σ,v)(l·n)+M^{c}CₑLₑ^{r}(c ∈ {r,g,b}) (3)

Here, the formula (3) will be rewritten by using a sampling point p as a variable. p is an appropriate resolution decided considering the resolution of the pattern of textures of the 3D geometrical model 21, and is sampled from the image data 23. I^{c}, v, n, M^{r}, M^{g} and M^{b} are functions of p, expressed as I^{c}(p), v(p), n(p), M^{r}(p), M^{g}(p) and M^{b}(p) respectively. As it is assumed that the materials of the objects are uniform in this case, rough stones, σ and ρ are constant.

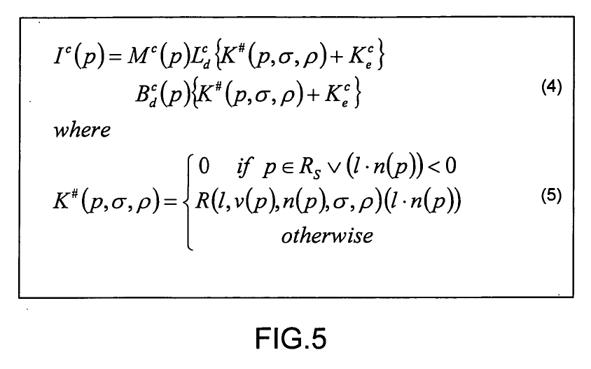

FIG. 5 shows rewritten formulas (4) and (5). In the formulas (4) and (5), Rₛ means the set of pixels on the surfaces with cast shadows. Since l is fixed on the scene and v(p) and n(p) are the functions of p, these variables are removed from the arguments of K#.

In the formula (4), specular reflection is neglected. It is because of the fact that the material dealt with as the object is the rough stone and the specular reflection on the surface is only a very minor element.

The influence of the shadows is separated by taking log of the formula (4). lnB^{c}_{d} is defined as the median of the distribution of lnB^{c}_{d}(p), and so e^{c}(p)=lnB^{c}_{d}(p)−lnB~^{c}_{d} is as in the following formula (6). In the formula (6), lnB~^{c}_{d}+e^{c}(p) depends on the material of the surface. And In {K#.(p, σ, ρ)+K^{c}ₑ} depends on the 3D geometrical model 21 (geometrical information).

$$\begin{matrix}ln {I}^{c} ( p ) = ln {B}_{d}^{c} ( p ) + ln \{ {K}^{\#} ( p , σ , ρ ) + {K}_{e}^{c} \} \\ = ln {\tilde{B}}_{d}^{c} + {ⅇ}^{c} ( p ) + ln \{ {K}^{\#} ( p , σ , ρ ) + {K}_{e}^{c} \}\end{matrix} \qquad ( 6 )$$

The shading estimation unit 13 determines the parameters σ, ρ, B^{c}_{d}(p) and K^{c}ₑ so that the pixel value of the sampled point p suits the formula (6).

Next, the image adaptation unit 14 obtains the sample from the image data 23 by using the correspondence information, and performs calculation for removing the effects of shadows and shadings from the pixel value of the sampled point so as to fit the calculated pixel value to the 3D geometrical model 21 (step S7).

To be more precise, the image adaptation unit 14 obtains pixel intensities (I^{r}(p), I^{g}(p), I^{b}(p)) from the pixel p of the image data 23. It also maps the geometrical information to the pixels of the image data 23 based on a camera parameter of the shooting information 24 so as to obtain n(p), v(p) and obtain l from the calculated direction of the sun (sₓ, s_{y}, s_{z}). And it sets n(p), v(p) and l in a local coordinate system Oₗ.

The image adaptation unit 14 may calculate the samples I^{c}(p) and K#.(p, σ, ρ) for each pixel of the image data 23. In this case, however, these samples are sampled from the image data 23 again at a lower resolution. It is because the resolution of the 3D geometrical model 21 is lower than that of the image data 23.

The image adaptation unit 14 divides the subject image data 23 into square regions (subregions) of which size is N by N. And it calculates I^{c}(p) and K#(p, σ, ρ) for each pixel and calculates the median of the region which is the value of the subregion.

The regions where K#(p, σ, ρ)=0 are the regions where the sunlight does not reach. Failing in fitting the samples at these regions often results in sharp differences at the edges of cast shadows. Therefore, the samples where K#(p, σ, ρ)=0 are very important even if the number is relatively small. The image adaptation unit 14 calculates these samples separately from the other samples by the following formula (7).

$$ln {\hat{I}}_{e}^{c} = med \{ ln {I}^{c} ( p ) \vert {K}^{\#} ( p , σ , ρ ) = 0 \} \qquad ( 7 )$$

The samples I^{c}(p) normally include many outliers. And n(p) obtained from the 3D geometrical model 21 includes many errors. Therefore, the image adaptation unit 14 uses the LMedS (Least Median Square) method to estimate σ, ρ and B^{˜c}_{d}. The estimation of LMedS is performed by minimizing the following formula (8).

$$\begin{matrix}F ( σ , ρ , {\tilde{B}}_{d}^{r} , {\tilde{B}}_{d}^{g} , {\tilde{B}}_{d}^{b} ) = med \{ {( ln {I}^{c} ( p ) - ln {I}^{c} ( p ) )}^{2} \vert c ∈ \{ r , g , b \} {∀}_{p} \} where & ( 8 ) \\ ln {\hat{I}}^{c} ( p ) = ln {\tilde{B}}_{d}^{c} + ln \{ {K}^{\#} ( p , σ , ρ ) + {\hat{I}}_{e}^{c} / {\tilde{B}}_{d}^{c} \} & ( 9 )\end{matrix}$$

Minimization of LMedS requires nonlinear optimization. Here, it is assumed that σ and ρ are constant, and so overall optimization can be converted as in the following formula (10).
F*(ρ, σ)=F(ρ, σ, B_{d}^{r}*(ρ, σ), B_{d}^{g}*(ρ, σ), B_{d}^{b}*(ρ, σ)) (10)

The image adaptation unit 14 minimizes two-variable function F*(ρ, σ) by using a simplex descending method. And it is defined as follows.

$$( \hat{σ} , \hat{ρ} ) = solutions of the optimization with σ and ρ \\ {\hat{B}}_{d}^{c} = {B}_{d}^{c *} ( \hat{σ} , \hat{ρ} ) , ( c ∈ \{ r , g , b \} ) \qquad ( {10}^{′} )$$

Thereafter, the image adaptation unit 14 determines the following parameters.

$$\hat{σ} , \hat{ρ} , {\hat{B}}_{d}^{c} , {\hat{I}}_{e}^{c} ( c ∈ \{ r , g , b \} ) \qquad ( {10}^{′′} )$$

The image adaptation unit 14 performs the calculation for removing the effects of the shadows or shadings by using estimated parameters for the pixel values sampled from the point p of the image data 23 based on the correspondence information. Here, the reflectance for each color M^{c} is necessary, but M^{c}(p) and L^{c}_{d} are inseparable. Therefore, it calculates B^{c}_{d}(p)=M^{c}(p)L^{c}_{d} instead. And it calculates the following formula (11) for each pixel of the 3D geometrical model 21 to obtain B^{c}_{d}(p). I^{c}(p) and K#(p, ρ, σ) in the formula (11) are sampled from each pixel.

$${B}_{d}^{c} ( p ) = {I}^{c} ( p ) / \{ {K}^{\#} ( p , σ , ρ ) + {\hat{I}}_{e}^{c} / {\tilde{B}}_{d}^{c} \} \qquad ( 11 )$$

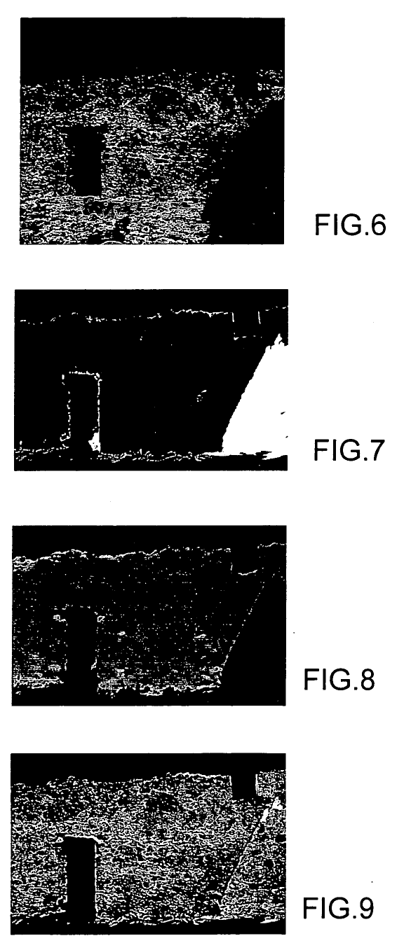

FIGS. 6 to 9 describe processing results of the present invention as to a first sample. FIG. 6 is a diagram showing an example of the image data 23 of the first sample (building). FIG. 7 is a diagram showing an example of a detected shadow region. FIG. 8 is a diagram showing an example of the shadings estimated by an optimized parameter (σ=62 degrees, ρ=0.53). FIG. 9 is a diagram showing an example of results of removing influence of the shadows and shadings from the image data 23.

As shown in FIG. 7, the shadow region detection unit 12 of the present invention detects the shadow region on the right side of the image data 23 correctly for the most part though there are some errors in boundaries at the top of the regions. As shown in FIG. 9, the light intensity of the shadow regions of the image data 23 is compensated correctly for the most part except some portions in which the pixel values are saturated.

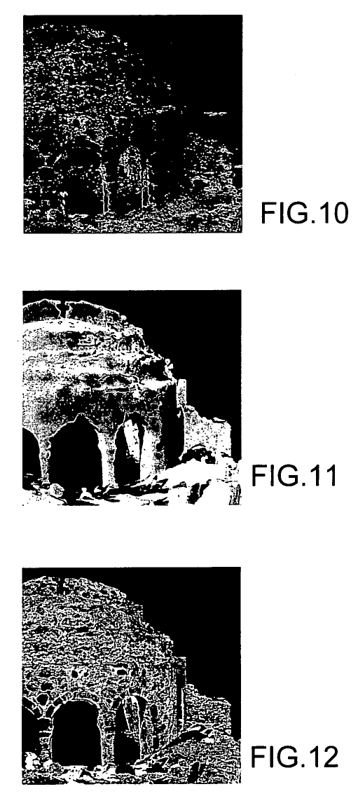

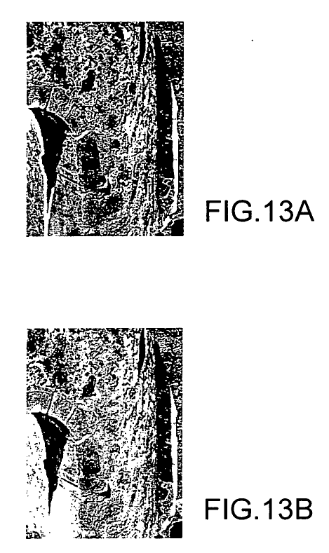

FIGS. 10 to 13 describe processing results of the present invention as to the second sample. FIG. 10 is a diagram showing an example of the image data 23 of the second sample. FIG. 11 is a diagram showing an example of the shading estimated with an optimized parameter (σ=46 degrees, ρ=0.55). FIG. 12 is a diagram showing an example of the results of removing the shadows and shadings from the image data 23. FIGS. 13 are diagrams showing an enlarged portion of the results shown in FIG. 12.

As shown in FIG. 10, the present invention can appropriately estimate and remove the effects of the shadings even in the case of the image data of the object in which structurally continuous gradients exist and the brightness of the image data changes according to the gradients. As for such continuous change in the brightness, the influence of the shadings cannot be removed simply by detecting the shadow portions.

As described above, the present invention calculates the direction of the light source (the sun) based on the geographic information and the shooting time of the object, detects the shadow regions from a calculated light direction, and estimates the effects of the shadings based on the reflection model of Oren-Nayar so as to perform the calculation for removing the effects of the shadows and shadings from the pixels sampled from the image data. The present invention performs these processes and thereby implements the processing method and processing apparatus for generating the 3D texture model not influenced by the shadows and shadings by using only one piece of the image data shot outdoors.

1. A processing method for generating a 3D texture model, wherein there are processes of:
obtaining a 3D geometrical model expressing a 3D form of an object by using geometrical information:
obtaining geographic information including latitude and longitude indicating a position of said object and orientation of the object;
obtaining image data of said object shot with the sun as a light source and correspondence information indicating correspondence between a scene expressed by said image data and said 3D geometrical model as to their positions and forms;
obtaining shooting information including information on a shooting time and shooting situation of said image data;
placing said 3D geometrical model in a predetermined local coordinate system based on said geographic information, and calculating a light source direction in said local coordinate system by using said geographic information and said shooting time;
detecting a shadow region cast on a surface of said 3D geometrical model by a beam in said light source direction by using said light source direction so as to identify the shadow region of said image data based on said correspondence information;
using a predetermined reflection model to estimate effects of shadings caused to said 3D geometrical model by the beam in said light source direction, and determining a parameter of the reflection model suited to said estimated shadings; and
performing calculation for removing the effects of the shadows and shadings by using said parameter from pixel values sampled from said image data based on said correspondence information so as to fit said calculated pixel values in said 3D geometrical model.

2. A processing apparatus for generating a 3D texture model, wherein the apparatus comprises:
processing means for storing a 3D geometrical model expressing a 3D form of an object by using geometrical information:
processing means for storing geographic information including latitude and longitude indicating a position of said object and orientation of the object;
processing means for storing image data of said object shot with the sun as a light source and correspondence information indicating correspondence between a scene expressed by said image data and said 3D geometrical model as to their positions and forms;
storing means for storing shooting information including information on a shooting time and shooting situation of said image data;
processing means for placing said 3D geometrical model in a predetermined local coordinate system based on said geographic information, and calculating a light source direction in said local coordinate system by using said geographic information and said shooting time;
processing means for detecting a shadow region cast on a surface of said 3D geometrical model by a beam in said light source direction by using said light source direction so as to identify the shadow region of said image data based on said correspondence information;
processing means for using a predetermined reflection model to estimate effects of shadings caused to said 3D geometrical model by the beam in said light source direction, and determining a parameter of the reflection model suited to said estimated shadings; and
processing means for performing calculation for removing the effects of the shadows and shadings by using said parameter from pixel values sampled from said image data based on said correspondence information so as to fit said calculated pixel values in said 3D geometrical model.

3. A recording medium having recorded a program for causing a computer to execute processes for generating a 3D texture model, wherein the program causes the computer to execute the processes of:
obtaining a 3D geometrical model expressing a 3D form of an object by using geometrical information:
obtaining geographic information including latitude and longitude indicating a position of said object and orientation of the object;
obtaining image data of said object shot with the sun as a light source and correspondence information indicating correspondence between a scene expressed by said image data and said 3D geometrical model as to their positions and forms;
obtaining shooting information including information on a shooting time and shooting situation of said image data;
placing said 3D geometrical model in a predetermined local coordinate system based on said geographic information, and calculating a light source direction in said local coordinate system by using said geographic information and said shooting time;
detecting a shadow region cast on a surface of said 3D geometrical model by a beam in said light source direction by using said light source direction so as to identify the shadow region of said image data based on said correspondence information;
using a predetermined reflection model to estimate effects of shadings caused to said 3D geometrical model by the beam in said light source direction, and determining a parameter of the reflection model suited to said estimated shadings; and
performing calculation for removing the effects of the shadows and shadings by using said parameter from pixel values sampled from said image data based on said correspondence information so as to fit said calculated pixel values in said 3D geometrical model.
